(19) United States
(12) Patent Application Publication
(10) Pub. No.: US 2015/0116069 A1
(43) Pub. Date: Apr. 30, 2015

(54) COIL COMPONENT AND METHOD OF MANUFACTURING THE SAME

(71) Applicant: SAMSUNG ELECTRO-MECHANICS CO., LTD., Suwon (KR)

(72) Inventors: Duck Jin AN, Suwon (KR); Soon Young KWON, Suwon (KR); Geun Young PARK, Suwon (KR)

(73) Assignee: SAMSUNG ELECTRO-MECHANICS CO., LTD., Suwon (KR)

(21) Appl. No.: 14/147,844

(22) Filed: Jan. 6, 2014

(30) Foreign Application Priority Data
Oct. 31, 2013 (KR) 10-2013-0131341

(51) Int. Cl. H01F 27/29; H01R 43/02; H01F 41/10; H01F 5/04; H01F 41/06

(52) U.S. Cl. CPC H01F 27/29; H01F 5/04; H01F 41/06; H01F 41/10; H01R 43/0235; H01F 2027/297
USPC 336/192; 29/605

(57) ABSTRACT

There are provided a coil component having external connecting terminals firmly coupled to a bobbin thereof, and a method of manufacturing the same. The coil component includes: a bobbin having a coil wound therein; and at least one external connecting terminal coupled to the bobbin so that one end thereof protrudes outwardly, wherein the external connecting terminal includes a terminal pin inserted into the bobbin and an extension part enlarges a cross-sectional area of the terminal pin in the bobbin.

### CROSS-REFERENCE TO RELATED APPLICATION

This application claims the benefit of Korean Patent Application No. 10-2013-0131341 filed on Oct. 31, 2013, with the Korean Intellectual Property Office, the disclosure of which is incorporated herein by reference.

### BACKGROUND

The present disclosure relates to a coil component and a method of manufacturing the same, and more particularly, to a coil component having external connecting terminals securely coupled to a bobbin thereof, and a method of manufacturing the same.

A switching mode power supply (SMPS) is generally used as a power supply in an electronic device such as a display device, a light emitting diode (LED) illumination device, or the like.

Such an SMPS, a module type power supply converting externally-supplied electricity to be appropriate for powering various electrical and electronic devices such as illumination devices, televisions (TVs), video cassette recorders (VCRs), switchboards, wireless communications devices, and the like, serves to control triggering for a high frequency of a commercial frequency or more and alleviate impacts using semiconductor switching characteristics.

Recently, as the LED illumination devices have been widely used in a range of fields, various attempts to dispose such an SMPS in relatively confine spaces inside LED lamps have been made.

The SMPS may have a plurality of coil components mounted therein. However, in the case in which the coil components are mounted on a board within a confined space, such as in an internal space of an LED lamp, it may be difficult to securely couple the coil components to the board.

Therefore, external connecting terminals electrically connecting the coil components to the board are separated from the coil components or the board in a process of attaching the SMPS to the LED lamp.

Therefore, a coil component to which external connecting terminals may be more securely coupled has been demanded.

### RELATED ART DOCUMENT

(Patent Document 1) Korean Utility Model Laid-open Publication No. 1998-050529

### SUMMARY

An aspect of the present disclosure may provide a coil component having external connecting terminals firmly coupled to a bobbin thereof, and a method of manufacturing the same.

An aspect of the present disclosure may also provide a coil component capable of being easily manufactured, and a method of manufacturing the same.

According to an aspect of the present disclosure, a coil component may include: a bobbin having a coil wound therein; and at least one external connecting terminal coupled to the bobbin so that one end thereof protrudes outwardly, wherein the external connecting terminal includes a terminal pin inserted into the bobbin and an extension part enlarges a cross-sectional area of the terminal pin in the bobbin.

The terminal pin may include an insertion part inserted into the bobbin and a connection part protruding outwardly of the bobbin and having the coil connected thereto.

The insertion part and the extension part may be formed in an L shape in the bobbin.

The extension part may have a form in which a portion of the terminal pin is embedded therein.

The extension part may protrude from an outer surface of the terminal pin.

The extension part may protrude from the center or a distal end of the insertion part in an outer diameter direction.

The terminal pin and the extension part of the external connection terminal may be formed of different materials.

The extension part may be formed of solder.

The bobbin may include an insertion groove having the terminal pin inserted thereinto and a terminal part having an accommodating groove formed therein, wherein the accommodating groove accommodates the extension part therein.

The insertion groove and the accommodating groove may have inlets formed in different directions in the terminal part, respectively, and may be connected to each other in the terminal part.

The insertion groove and the accommodating groove may be generally L-shaped.

The accommodating groove may have a form in which it penetrates through the terminal part.

The accommodating groove may have a width wider than that of the insertion groove.

According to another aspect of the present disclosure, a method of manufacturing a coil component may include: inserting a terminal pin into an insertion groove of a bobbin; and forming an extension part at the terminal pin by impregnating the bobbin into which the terminal pin is inserted into melted solder.

In the inserting of the terminal pin, the terminal pin may be inserted into the insertion groove so that a portion thereof is exposed to an accommodating groove extended from the insertion groove.

In the forming of the extension part, the accommodating groove may be inserted into the melted solder to form the extension part from a portion exposed through the accommodating groove.

The method may further include, after the inserting of the terminal pin, winding a coil in the bobbin and connecting a lead wire of the coil to the terminal pin.

In the forming of the extension part, the lead wire connected to the terminal pin may be inserted into the melted solder.

According to another aspect of the present disclosure, a coil component may be manufactured using the method described above.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a perspective view schematically illustrating a coil component according to an exemplary embodiment of the present disclosure;

FIG. 2 is an enlarged perspective view of a terminal part of the coil component shown in FIG. 1;

FIG. 3 is a partially cut-away view of the terminal part shown in FIG. 2;

FIG. 4 is a cross-sectional view of the terminal part taken along line A-A of FIG. 2;

FIGS. 5A through 5D are views for describing a method of manufacturing a coil component according to an exemplary embodiment of the present disclosure;

FIG. 6 is a partial perspective view schematically illustrating a terminal part of a coil component according to another exemplary embodiment of the present disclosure;

FIG. 7 is a cross-sectional view taken along line C-C of FIG. 6;

FIG. 8 is a partial perspective view schematically illustrating a terminal part of a coil component according to another exemplary embodiment of the present disclosure;

FIG. 9 is a cross-sectional view taken along line C-C of FIG. 8;

FIG. 10 is a partial perspective view schematically illustrating a terminal part of a coil component according to another exemplary embodiment of the present disclosure; and

FIG. 11 is a cross-sectional view taken along line C-C of FIG. 10.

### DETAILED DESCRIPTION

Hereinafter, embodiments of the present invention will be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the shapes and dimensions of elements may be exaggerated for clarity, and the same reference numerals will be used throughout to designate the same or like elements.

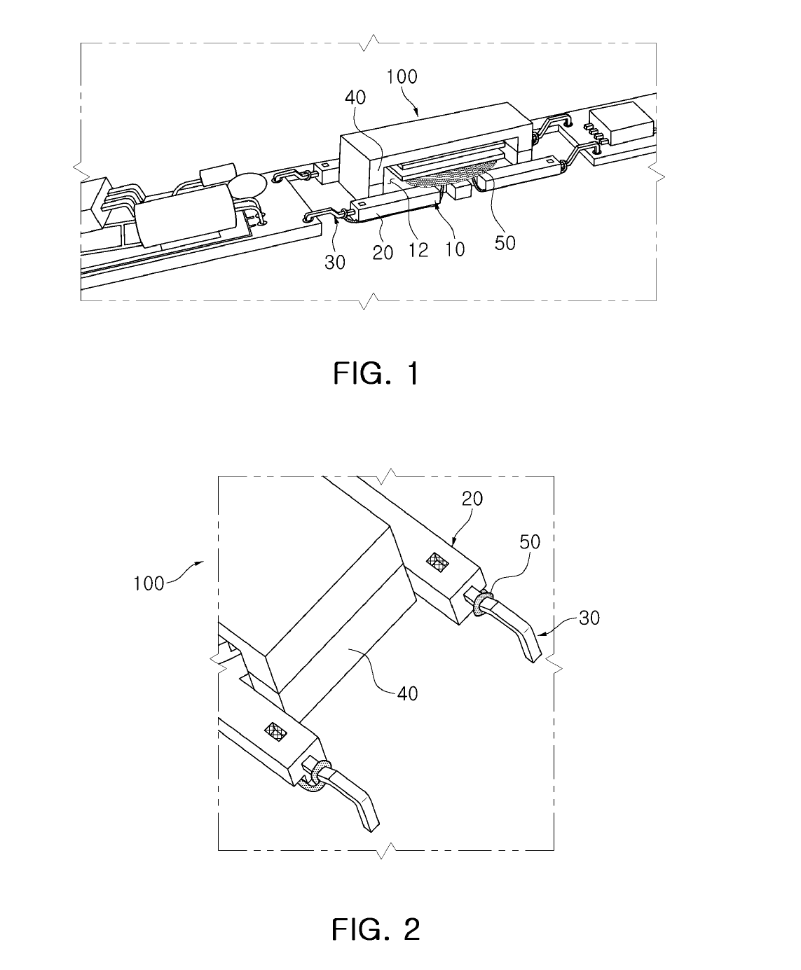

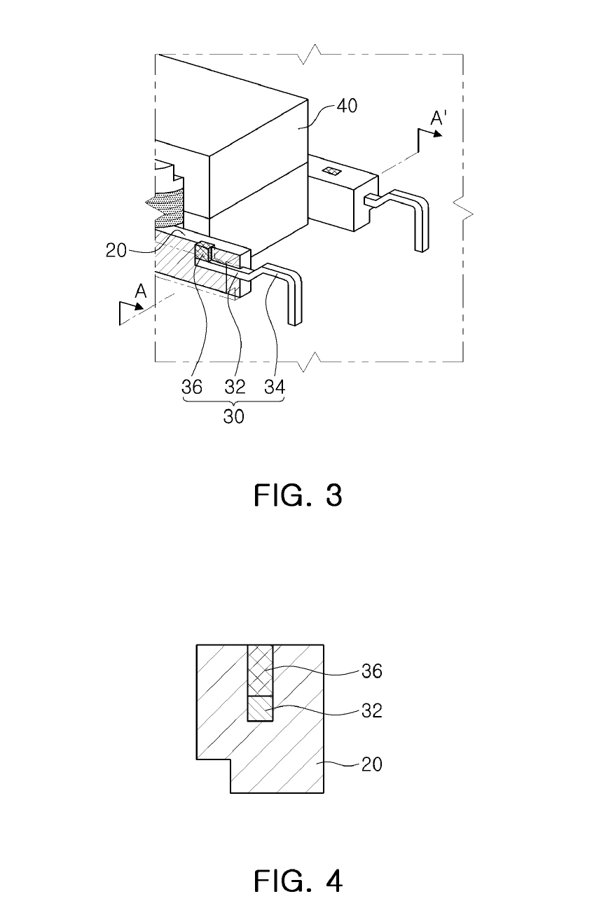

FIG. 1 is a perspective view schematically illustrating a coil component according to an exemplary embodiment of the present disclosure; and FIG. 2 is an enlarged perspective view of a terminal part of the coil component shown in FIG. 1. In addition, FIG. 3 is a partially cut-away view of the terminal part shown in FIG. 2; and FIG. 4 is a cross-sectional view of the terminal part taken along line A-A of FIG. 2.

Referring to FIGS. 1 through 4, the coil component 100 according to an exemplary embodiment of the present disclosure may be a transformer and may include a coil 50, a bobbin 10, external connecting terminals 30, and a core 40.

The coil 50 may be provided in singular or plural. Further, in the case in which the coil component 100 according to this exemplary embodiment is the transformer, the coil 50 may include primary and secondary coils.

The coil 50 may be wound in a winding part 12 of a bobbin 10 to be described below, and lead wires of both ends of the coil 50 may be connected to external connecting terminals 30 to be described below, respectively. A plurality of coils 50 may be wound in the winding part 12. In this case, the respective coils may have different thicknesses and different turn amounts.

The core 40 may be inserted into a hole formed in the bobbin 10. The core 40 according to this exemplary embodiment may be configured as a pair thereof. The pair of cores 40 may be inserted into the hole of the bobbin 10 from both distal end portions of the bobbin 10 to thereby be coupled to each other while facing each other. The core 40 is not limited to having a shape shown in the accompanying drawings, but may have a shape such as an ‘E’ shape, a ‘U’ shape, an ‘I’ shape, or the like. In addition, the core 40 may be made of Mn—Zn based ferrite having higher permeability, lower loss, higher saturation magnetic flux density, higher stability, and lower production costs, as compared with other materials. However, in an exemplary embodiment of the present disclosure, a shape or a material of the core 40 is not limited.

The bobbin 10 may include the winding part 12 having the coil 50 wound therein and a terminal part 20 formed on one side of the winding part 12.

The terminal part 20 may have a form in which it protrudes outwardly from the winding part 12. In addition, the terminal part 20 may have the external connecting terminal 30 coupled to a distal end thereof.

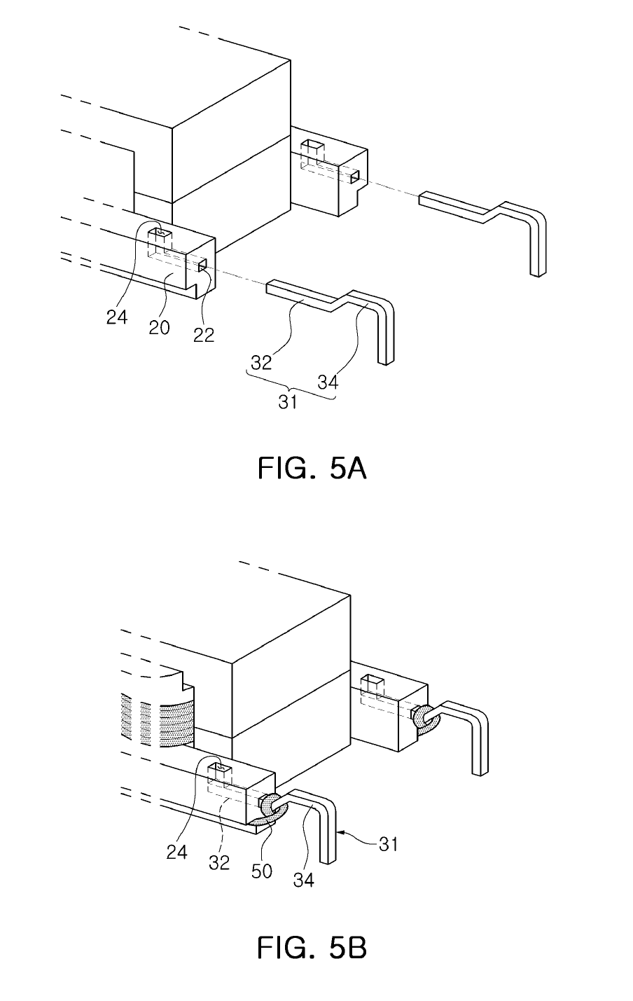

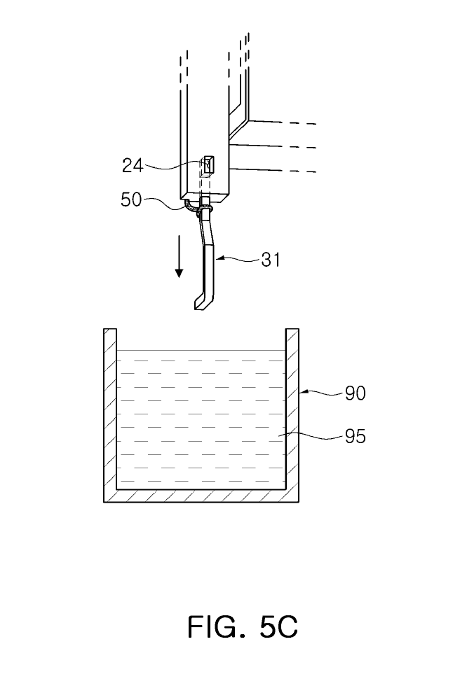

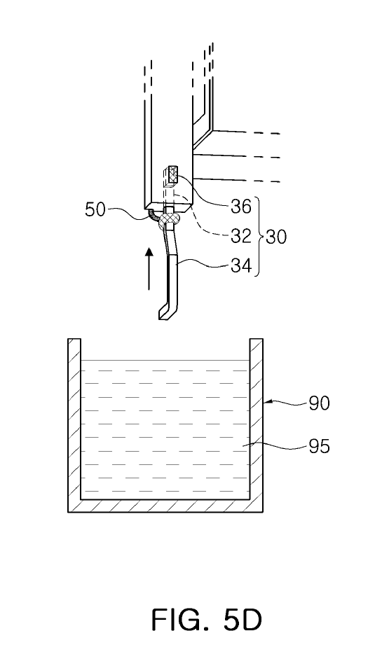

Particularly, the terminal part 20 according to this exemplary embodiment may include an insertion groove 22 into which the external connecting terminal 30 is inserted and an accommodating groove 24 in which an extension part 36 of the external connecting terminal 30 is disposed, as shown in FIG. 5A.

The insertion groove 22 may have an insertion part 32 of the external connecting terminal 30 inserted thereinto, and the accommodating groove 24 may accommodate the extension part 36 of the external connecting terminal 30 therein. To this end, the insertion groove 22 may be formed as a through-hole having a shape of a straight line so that the insertion part 32 of the external connecting terminal 30 may be easily inserted thereinto. In addition, the accommodating groove 24 may be connected to the insertion groove 22 at one end or the center of the insertion groove 22 and may have a shape of a groove opened to the outside of the terminal part 20.

The accommodating groove 24 may be formed from the insertion groove 22 in a direction different from a direction in which the insertion groove 22 is formed and have a cross section wider than that of the insertion groove 22 as in this exemplary embodiment. However, the accommodating groove 24 is not limited to having a cross section wider than that of the insertion groove 22, but may also have a cross section that is the same as or smaller than that of the insertion groove 22.

The accommodating groove 24 and the insertion groove 22 may have inlets formed in different directions in the terminal part 20, respectively. That is, the accommodating groove 24 and the insertion groove 22 may have the inlets formed in different surfaces of the terminal part 20, respectively, and may be connected to each other in the terminal part 20. Therefore, the accommodating groove 24 and the insertion groove 22 may have a shape of a through-hole in which a bend is formed in the terminal part 20.

In this exemplary embodiment, the accommodating groove 24 and the insertion groove 22 may have a form in which they are approximately perpendicular to each other. Therefore, the accommodating groove 24 and the insertion groove 22 may be generally L-shaped.

The bobbin 10 according to this exemplary embodiment configured as described above may be easily manufactured by injection molding, but is not limited thereto. That is, the bobbin 10 may also be manufactured using various methods such as a press working method, and the like. In addition, the bobbin 10 according to this exemplary embodiment may be formed of an insulating resin and may be formed of a material having high heat resistance and high voltage resistance. As a material of the bobbin 10, polyphenylenesulfide (PPS), liquid crystal polyester (LCP), polybutyleneterephthalate (PBT), polyethyleneterephthalate (PET), phenolic resin, or the like, may be used.

The external connecting terminal 30 may be coupled to the terminal part 20 so that one end thereof protrudes outwardly from the terminal part 20 and may have various shapes depending on a shape or a structure of the coil component 100 or a structure of a board on which the coil component 100 is mounted.

The external connecting terminal 30 according to this exemplary embodiment may have a terminal pin 31 and the extension part 36.

The terminal pin 31 may be a general terminal pin 32 or 34 (31 of FIG. 5a) used in the coil component 100 and may be formed of a conductive material such as a metal, or the like.

The terminal pin 31 according to this exemplary embodiment may be divided into a connection part 34 protruding outwardly of the terminal part 20 of the bobbin 10 and the insertion part 32 inserted into the terminal part 20 of the bobbin 10.

The connection part 34, which is a part exposed at the terminal part 20, may mean a part having the coil 50 connected thereto and mounted on the board, as shown in FIG. 1. Therefore, the connection part 34 may have a form in which it may be easily mounted on the board simultaneously with having the coil 50 easily coupled thereto.

The insertion part 32 may have a linear shape extended from the connection part 34 and may be inserted into the insertion groove 22 (See FIG. 5A) of the bobbin 10.

In the coil component 100 according to this exemplary embodiment, the bobbin 10 and the external connecting terminal 30 may be integrated with each other by manufacturing the bobbin 10 and then inserting and fixing the external connecting terminal 30 into the insertion groove 22 of the bobbin 10. Therefore, the insertion part 32 may be extendedly formed in a shape of a pin so as to be easily inserted into the insertion groove 22.

The connection part 34 and the insertion part 32 may be formed integrally with each other. That is, the connection part 34 and the insertion part 32 may be formed by manufacturing the terminal pin 31 in a shape of a straight line and then bending the terminal pin 31. Therefore, the connection part 34 and the insertion part 32 may be formed of the same material.

The extension part 36 may be provided in order to firmly fix the terminal pin 31 into the terminal part 20. To this end, the extension part 36 may have a form in which it enlarges a volume (or cross-sectional area) of the terminal pin 31 from the center or a distal end of the insertion part 32.

More specifically, the extension part 36 may protrude from an outer surface of the insertion part 32. However, a shape of the extension part is not limited thereto, but may be variously changed as in another exemplary embodiment to be described below.

The extension part 36 may be accommodated in the accommodating groove 24 (See FIG. 5) of the bobbin 10. Therefore, the extension part 36 and the insertion part 32 may be generally L-shaped, depending on shapes of the accommodating groove 24 and the insertion groove 22. As a result, the external connecting terminal 30 may not be easily separated from the bobbin 10.

The extension part 36 may be formed by inserting the terminal part 20 of the bobbin 10 into melted solder 95 (See FIG. 5C) after the insertion part 32 is inserted into the bobbin 10. That is, the accommodating groove 24 is filled with the melted solder 95 which is then hardened, whereby the extension part 36 may be bonded to the insertion part 32 while protruding therefrom.

Therefore, the extension part 36 may be formed of solder. However, the extension part 36 is not limited to being formed of the solder material, but may be formed of any material as long as the extension part 36 may be formed through the accommodating groove 24 after the insertion part 32 is inserted into the terminal part 20.

In addition, since the extension part 36 is formed of the melted solder 95, the terminal pin 31 and the extension part 36 of the external connecting terminal according to this exemplary embodiment may be formed of different materials. However, the terminal pin 31 and the extension part 36 may also be formed of the same material.

In the coil component according to this exemplary embodiment configured as described above, although a terminal insertion type bobbin which is manufactured and then has the external connecting terminal coupled thereto is used, the external connecting terminal inserted into the bobbin may not be easily separated from the bobbin by the extension part formed in the external connecting terminal. Therefore, the coil component capable of being easily manufactured and firmly coupling the external connecting terminal to the bobbin may be provided.

Next, a method of manufacturing a coil component according to this exemplary embodiment will be described.

FIGS. 5A through 5D are views illustrating a method of manufacturing a coil component according to an exemplary embodiment of the present disclosure.

Referring to FIGS. 5A through 5D, first, the terminal pin 31 may be coupled to the bobbin 10, as shown in FIG. 5A. Here, the terminal pin 31 may be configured only of the connection part 34 and the insertion part 32. In addition, the insertion part 32 may be inserted into the insertion groove 22 of the bobbin 10, such that the terminal pin 31 is coupled to the bobbin 10.

Therefore, in this state, the terminal pin 31 may be easily separated from the bobbin 10.

In this process, the insertion part 32 may be inserted into the insertion groove 22 so that at least a portion thereof is exposed to the outside through the accommodating groove 24.

Then, as shown in FIG. 5B, after the coil 50 is wound in the bobbin 10, a lead wire of the coil 50 may be connected to the connection part 34 of the terminal pin 31.

When the winding of the coil 50 is completed, the terminal pin 31 may be inserted into a tank 90 in which the melted solder 95 is accommodated, as shown in FIG. 5C. In this case, a portion of the terminal part 20 of the bobbin 10 as well as the terminal pin 31 may be inserted into the tank 90. More specifically, the accommodating groove 24 of the terminal part 20 may be inserted into the tank 90.

Therefore, as shown in FIG. 5D, the accommodating groove 24 may be filled with the melted solder 95 while contacting the insertion part 32 exposed through the accommodating groove 24. In addition, the melted solder 95 may also be applied to the connection part 34 and the coil 50 connected to the connection part 34.

Then, after the bobbin 10 is removed from the tank 90, the melted solder 95 may be hardened. Therefore, the connection part 34 and the coil 50 may be firmly bonded to each other by the solder.

In addition, the extension part 36 coupled to the insertion part 32 may be formed in the accommodating groove 24. The extension part 36 may be formed by hardening the melted solder 95 filled in the accommodating groove 24 and be physically coupled to the insertion part 32 exposed to the accommodating groove 24. Here, since the coupling between the extension part 36 and the insertion part 32 is metallic bonding, the extension part 36 and the insertion part 32 may not be easily separated from each other.

Since the extension part 36 protrudes from the insertion part 32 to extend a cross-sectional area of the insertion part 32, it may prevent the external connecting terminal 30 from being separated from the bobbin 10.

In the method of manufacturing a coil component according to the exemplary embodiment configured as described above, after the bobbin and the terminal pin are separately manufactured, the terminal pin may be inserted into the bobbin to complete the coil component. Therefore, the coil component may be very easily manufactured.

Further, in the method of manufacturing a coil component according to this exemplary embodiment, the extension part may be formed in the external connecting terminal using a process according to the related art in which a connection portion between the coil and the external connecting terminal is inserted into the melted solder. Therefore, the external connecting terminal may be firmly coupled to the bobbin 10 without a separate process.

Meanwhile, the coil component according to the present disclosure is not limited to the above-mentioned exemplary embodiment, and may have various embodiments applied thereto.

A coil component to be described below may have a structure similar to that of the coil component 100 (See FIG. 1) according to the above-mentioned exemplary embodiment, except for structures of a terminal part and an external connecting structure. Therefore, a detailed description of the same components will be omitted, and a terminal part and an external connecting terminal will be described in greater detail.

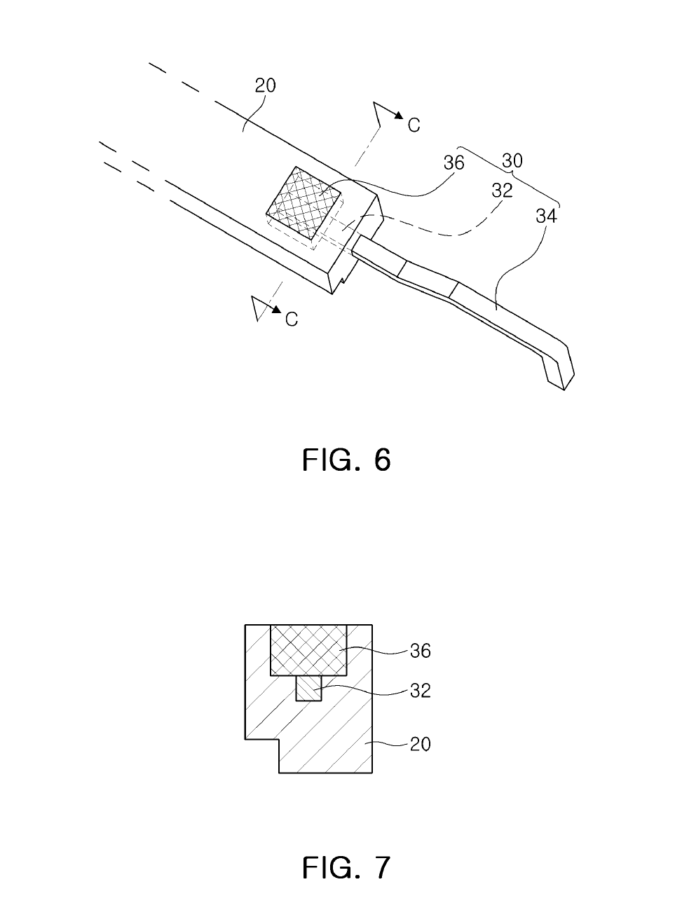

Meanwhile, in FIGS. 6 through 11 to be described below, only a terminal part of a bobbin is shown for convenience of explanation.

FIG. 6 is a partial perspective view schematically illustrating a terminal part of a coil component according to another exemplary embodiment of the present disclosure. In FIG. 6, only a terminal part of a bobbin to which an external connecting terminal is coupled is shown. In addition, FIG. 7 is a cross-sectional view taken along line C-C of FIG. 6.

Referring to FIGS. 6 and 7, in the coil component according to this exemplary embodiment, an accommodating groove 24 of a terminal part 20 may have a width wider than that of an insertion groove 22. Therefore, an extension part 36 may also have a width wider than that of an insertion part 32.

In this case, since the extension part 36 is formed to have a larger size, coupling force between the extension part 36 and the terminal part 20 may be increased.

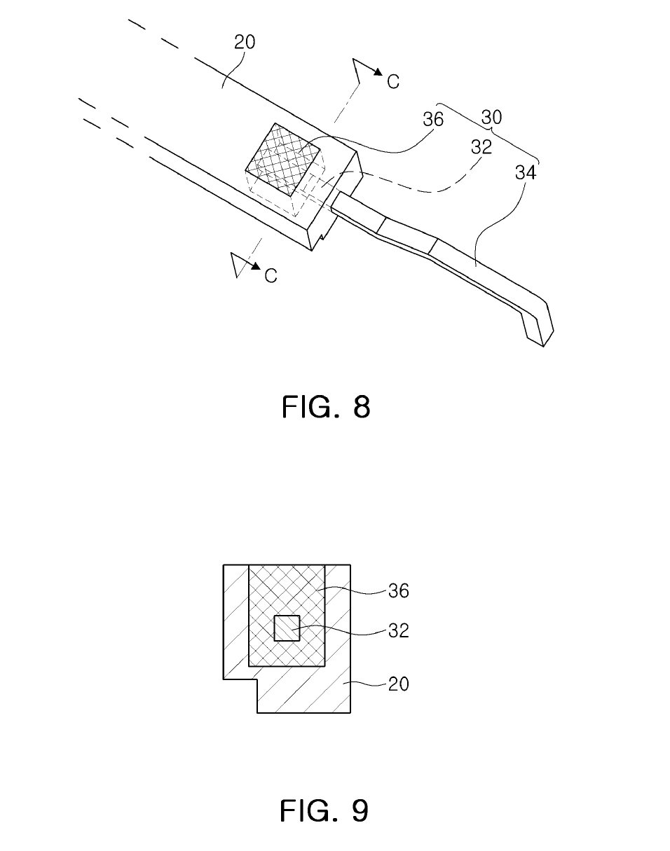

FIG. 8 is a partial perspective view schematically illustrating a terminal part of a coil component according to another exemplary embodiment of the present disclosure. In FIG. 8, only a terminal part of a bobbin to which an external connecting terminal is coupled is shown. In addition, FIG. 9 is a cross-sectional view taken along line C-C of FIG. 8.

Referring to FIGS. 8 and 9, in the coil component according to this exemplary embodiment, an accommodating groove 24 of a terminal part 20 may have a form in which it extends an insertion groove 22 from a distal end of the insertion groove 22. Therefore, an insertion part 32 disposed in the accommodating groove 24 may be formed so that an outer surface thereof is entirely exposed to the outside.

Therefore, an extension part 36 may have a form in which it protrudes from the center or a distal end of the insertion part 32 in an outer diameter direction from the insertion part 32. As a result, the insertion part 32 may have a form in which a portion thereof is embedded in the extension part 36.

In the coil component according to this exemplary embodiment as described above, since the extension part 36 is formed through the entirety of the exposed outer surface of the insertion part 32, the insertion part 32 and the extension part 36 may be bonded to each other over a wider area, such that coupling force between the insertion part 32 and the extension part 36 may be increased.

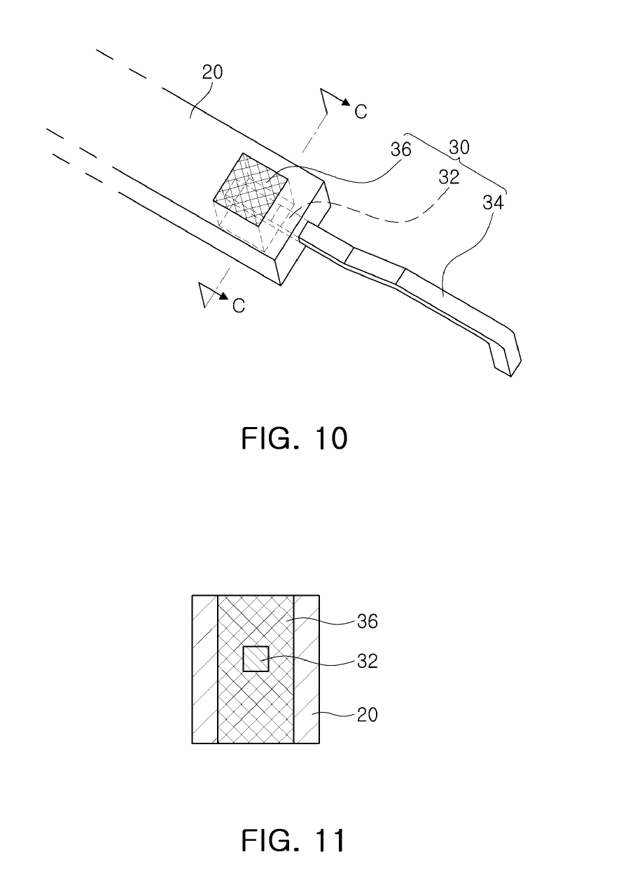

FIG. 10 is a partial perspective view schematically illustrating a terminal part of a coil component according to another exemplary embodiment of the present disclosure. In FIG. 8, only a terminal part of a bobbin to which an external connecting terminal is coupled is shown. In addition, FIG. 11 is a cross-sectional view taken along line C-C of FIG. 10.

Referring to FIGS. 10 and 11, in the coil component according to this exemplary embodiment, an accommodating groove 24 may have a shape of a through-hole penetrating through a terminal part 20, and a distal end of an insertion groove 22 may be connected to the accommodating groove 24.

Therefore, similar to the above-mentioned exemplary embodiments, an insertion part 32 disposed in the accommodating groove 24 may be formed so that an outer surface thereof is entirely exposed to the outside and may be bonded to an extension part 36 through the entirety of the exposed outer surface thereof.

Therefore, coupling force between the insertion part 32 and the extension part 36 may be further increased and a size of the extension part 36 may be extended. Accordingly, coupling force between an external connecting terminal 30 and the terminal part 20 may also be increased.

Meanwhile, the coil component and the method of manufacturing the same according to the present disclosure described hereinabove are not limited to the above-mentioned exemplary embodiments, but may be variously applied. For example, the case in which a single extension part is formed in the external connecting terminal has been described by way of example in the above-mentioned exemplary embodiments. However, the present disclosure is not limited thereto. That is, a plurality of extension parts may also be formed at several positions of the insertion part, respectively, if necessary.

In addition, although the transformer has been described by way of example in exemplary embodiments of the present disclosure, the present disclosure is not limited thereto, but may be widely applied to a coil component or an electronic device including a coil and an external connecting terminal to which a lead wire of the coil is connected.

With the coil component according to exemplary embodiments of the present disclosure, although a terminal insertion type bobbin manufactured and then having the external connecting terminal coupled thereto is used, the external connecting terminal inserted into the bobbin may not be easily separated from the bobbin by the extension part formed in the external connecting terminal. Therefore, the coil component capable of being easily manufactured and firmly coupling the external connecting terminal to the bobbin may be provided.

In addition, with the method of manufacturing a coil component according to an exemplary embodiment of the present disclosure, after the bobbin and the external connecting terminal are separately manufactured, the external connecting terminal may be inserted into the bobbin to complete the coil component. Therefore, the coil component may be very easily manufactured.

Further, with the method of manufacturing a coil component according to an exemplary embodiment of the present disclosure, the extension part may be formed in the external connecting terminal using a process according to the related art in which a connection portion between the coil and the external connecting terminal is inserted into the melted solder. Therefore, the external connecting terminal may be firmly coupled to the bobbin without adding a separate new process.

While exemplary embodiments have been shown and described above, it will be apparent to those skilled in the art that modifications and variations could be made without departing from the spirit and scope of the present disclosure as defined by the appended claims.

What is claimed is:

1. A coil component comprising:
a bobbin having a coil wound therein; and
at least one external connecting terminal coupled to the bobbin so that one end thereof protrudes outwardly,
wherein the external connecting terminal includes a terminal pin inserted into the bobbin and an extension part enlarges a cross-sectional area of the terminal pin in the bobbin.

2. The coil component of claim 1, wherein the terminal pin includes an insertion part inserted into the bobbin and a connection part protruding outwardly of the bobbin and having the coil connected thereto.

3. The coil component of claim 2, wherein the insertion part and the extension part are formed in an L shape in the bobbin.

4. The coil component of claim 1, wherein the extension part has a form in which a portion of the terminal pin is embedded therein.

5. The coil component of claim 1, wherein the extension part protrudes from an outer surface of the terminal pin.

6. The coil component of claim 1, wherein the extension part protrudes from the center or a distal end of the insertion part in an outer diameter direction.

7. The coil component of claim 1, wherein the terminal pin and the extension part of the external connection terminal are formed of different materials.

8. The coil component of claim 7, wherein the extension part is formed of solder.

9. The coil component of claim 1, wherein the bobbin includes an insertion groove having the terminal pin inserted thereinto and a terminal part having an accommodating groove formed therein, the accommodating groove accommodating the extension part therein.

10. The coil component of claim 9, wherein the insertion groove and the accommodating groove have inlets formed in different directions in the terminal part, respectively, and are connected to each other in the terminal part.

11. The coil component of claim 9, wherein the insertion groove and the accommodating groove are generally L-shaped.

12. The coil component of claim 9, wherein the accommodating groove has a form in which it penetrates through the terminal part.

13. The coil component of claim 9, wherein the accommodating groove has a width wider than that of the insertion groove.

14. A method of manufacturing a coil component, comprising:
inserting a terminal pin into an insertion groove of a bobbin; and
forming an extension part at the terminal pin by impregnating the bobbin into which the terminal pin is inserted into melted solder.

15. The method of claim 14, wherein in the inserting of the terminal pin, the terminal pin is inserted into the insertion groove so that a portion thereof is exposed to an accommodating groove extended from the insertion groove.

16. The method of claim 15, wherein in the forming of the extension part, the accommodating groove is inserted into the melted solder to form the extension part from a portion exposed through the accommodating groove.

17. The method of claim 14, further comprising, after the inserting of the terminal pin, winding a coil in the bobbin and connecting a lead wire of the coil to the terminal pin.

18. The method of claim 17, wherein in the forming of the extension part, the lead wire connected to the terminal pin is inserted into the melted solder.

19. A coil component manufactured by the method of claim 14.
